(19) United States
(12) Patent Application Publication
(10) Pub. No.: US 2020/0286143 A1
(43) Pub. Date: Sep. 10, 2020

(54) CUSTOMIZED ELECTRONIC CONTENT DELIVERY

(71) Applicant: LiveCard, LLC, Brooklyn, NY (US)

(72) Inventors: Chad Wood, Brooklyn, NY (US); Darren Bassman, Brooklyn, NY (US); Daniel Panzer, New York, NY (US)

(21) Appl. No.: 16/809,501

(22) Filed: Mar. 4, 2020

Related U.S. Application Data
(60) Provisional application No. 62/813,715, filed on Mar. 4, 2019.

(51) Int. Cl. G06Q 30/06; H04W 4/12; H04L 12/58

(52) U.S. Cl. CPC G06Q 30/0621; H04L 51/10; H04W 4/12; G06Q 30/0633

(57) ABSTRACT

Systems and methods for associating a gift message with a purchased item are presented. A purchaser of an item is given an opportunity to upload, create, edit, and/or modify a gift message for electronic delivery to a recipient in association with the delivery of the purchased item. A gift message may comprise one or more of video, image, audio, text, and/or other data and content types, all of which can be electronically delivered to a recipient. Upon receiving notice of delivery to a recipient of a purchased item, a notification is electronically sent to the recipient indicating the delivery of the purchased item. The notification includes encoded information, sometimes in the form of a link or hyperlink, that when traversed, provides access of the gift message to the recipient or other viewer(s).

### CROSS-REFERENCE TO RELATED MATTERS

This application claims the benefit of U.S. Provisional Patent Application No. 62/813,715, filed on Mar. 4, 2019, which is incorporated herein by reference.

### BACKGROUND

Purchasing items and services online using so-called E-commerce merchants is a common practice among consumers. Various factors have driven the prevalence of online purchases including convenience, i.e., purchasing from the confines of one's own residence, relatively fast delivery to either the purchaser or an intended recipient, wide selection of items including hard-to-find items, and the like.

One of the drawbacks of online purchasing is the reduction of inter-personal interaction or communication. When a person purchases a gift item for a friend or relative, that item can be, and often is, delivered directly to the intended recipient. Indeed, E-commerce merchants, or any merchants or manufacturers that ship products directly to customers, fail to offer purchasers with the ability to send digital content along with the physical shipment of a gift package. For example, purchasers (using online E-commerce merchants) are largely restricted to checkout experiences that have little to no customization of gift message content. Sadly, currently gift messages are severely limited, with some merchants only allowing 140 text characters as an “inter-personal message” while other merchants simply offer no customization at all. When offered, these “gift messages” are printed on order invoices. Of course, the purchaser has no control over how or where a gift message is displayed to a recipient. In fact, these gift messages are usually relegated to the bottom of an invoice and the invoice is discarded without the gift message being seen by the recipient. This leads to many instances of purchasers having purchased items shipped to their residence prior to being sent to the intended recipient so the gift item can be repackaged and reshipped to the intended recipient with a personalized gift message completed by the purchaser. Obviously, this results in substantial waste of person time and effort, as well as shipping resources and associated costs.

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIG. 1 is a pictorial diagram of an exemplary network environment suitable for implementing one or more aspects of the disclosed subject matter;

FIG. 2 is a flow diagram illustrating an exemplary routine for providing a purchaser-provided gift message to a recipient of a purchased item, in accordance with aspects of the disclosed subject matter;

FIG. 3 is a flow diagram illustrating an exemplary routine for providing access to a gift message to an intended recipient, in accordance with aspects of the disclosed subject matter;

FIG. 4 is a block diagram illustrating an exemplary gift message table for managing gift messages according to aspects of the disclosed subject matter;

FIG. 5 is a block diagram of an exemplary computer-readable medium encoded with instructions for providing a purchaser-provided gift message to a recipient of a purchased item, in accordance with aspects of the disclosed subject matter; and

FIG. 6 is a block diagram illustrating exemplary components of a computer system suitable for providing a purchaser-provided gift message to a recipient of a purchased item, in accordance with aspects of the disclosed subject matter.

### DETAILED DESCRIPTION

According to aspects of the disclosed subject matter, a merchant may advantageously provide a gift facility to purchasers. More particularly, the gift messaging facility provides a purchaser with the ability to create highly customizable gift messages that include, by way of illustration and not limitation, textual content, audio and/or audio/visual content, images, and the like. In various embodiments, the purchaser can indicate that he/she wishes to provide or generate a gift message during the checkout flow of purchasing an item for a target recipient. According to aspects of the disclosed subject matter, the gift messaging facility delivers the gift message content or, alternatively, access to the gift message content, digitally to the recipient at a specified date and time. In various instances, this date and time may coincide with the date and time when the purchased item is delivered to the recipient. In accordance with various aspects of the disclosed subject matter, the gift message facility may comprise a collection of software modules, APIs and/or SDKs through which the purchaser may create and/or provide a message for delivery to the recipient. Indeed, the gift message facility may include both a purchaser interface that enables the purchaser to create or upload gift message content and a recipient interface that displays the gift message content to the recipient.

In addition to the inability to provide robust gift messaging, another disadvantage of previous efforts of merchants is the complete lack of connection of the merchant with the recipient of a purchased item after the purchased item is delivered. Clearly, this lack of connection is founded on the fact that the item was purchased by the purchaser, not the recipient. Thus, subsequent communication with a recipient would only happen if the recipient desired to return or exchange the item. Advantageously, aspects of the disclosed subject matter provide merchants with the ability to connect with a recipient through the provision of the gift message content.

For purposes of clarity and by way of definition, the term “exemplary,” as used in this document, should be interpreted as serving as an illustration or example of something, and it should not be interpreted as an ideal or leading illustration of that thing. Stylistically, when a word or term is followed by “(s)”, the meaning should be interpreted as indicating the singular or the plural form of the word or term, depending on whether there is one instance of the term/item or whether there is one or multiple instances of the term/item. For example, the term “user(s)” should be interpreted as one or more users. Moreover, the use of the combination “and/or” regarding multiple items should be viewed as meaning either or both items.

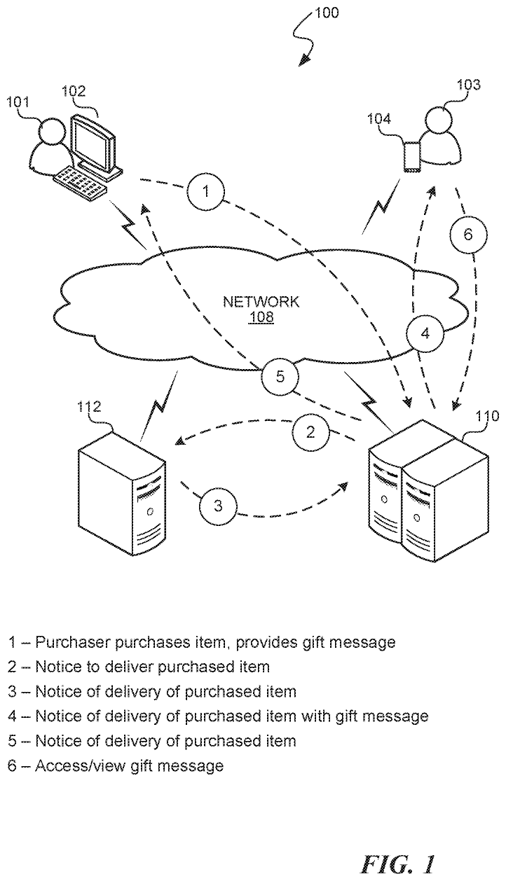

Turning to the figures, FIG. 1 is a block diagram illustrating an exemplary network environment 100 suitable for implementing one or more aspects of the disclosed subject matter. The exemplary network environment 100 includes one or more computer users, such as computer users 101 and 103. Exemplary computing devices suitable for use in the network environment 100 include, by way of illustration and not limitation, desktop computers (e.g., computer 102), laptop computers, tablet computers, the so-called “phablet” computing devices (i.e., hybrid mobile phone/tablet devices), mobile phones (e.g., mobile phone 104), mini- and/or mainframe computers, so-called “thin clients” (i.e., a lightweight computer optimized for interacting with a remote server computer over a network), and the like. As those skilled in the art will appreciate, each computer or computing device has a distinct set of display and audio features for presenting content to a corresponding computer user. As will be discussed below, gift messages may be advantageously adapted for presentation on a receiving computer/computing device according to the capabilities and features of the device/computer.

According to aspects of the disclosed subject matter, the various computers and/or computing devices, e.g., computing devices 102 and 104, are network enabled, meaning that each device includes features that enable the device to communicate with other computers, computing devices, network enabled devices and networked services via a computer network 108, synonymously referred to as a data network and/or a communication network. As those skilled in the art will appreciate, a computer network 108 is fundamentally a telecommunications network over which the various connected computers, computing devices and network-enabled services can electronically communicate. As those skilled in the art will appreciate, in computer network environments, such as network environment 100, networked computing devices are viewed as nodes on the network 108. Thus, in FIG. 1, computing device 102 and online service 110 are both viewed as network nodes. The various electronic communications between nodes includes the exchange information and data which, according to aspects of the disclosed subject matter, may be used to purchase an item (or service) from an online merchant, provide a gift message in association with the purchased item, and have both the purchased item and the gift message provided to a recipient.

By way of definition, the network 108 is a computer network, synonymously referred to as a data network. As those skilled in the art will appreciate, the computer network 108 is fundamentally a telecommunications network over which computers, computing devices such as user computing device 102, and other network-enabled devices and services, such as online service 110, can electronically communicate, including exchanging information and data.

In communicating with other devices over the network 108, connections between network nodes and the network comprise either cable media (electronic and/or optical connections based on physical structures such as wires or fibers), wireless media (wireless connections or transmissions between wireless transceivers), or a combination of both. While a well-known computer network is the Internet, the disclosed subject matter is not limited to the Internet. Indeed, elements of the disclosed subject matter may be suitably and satisfactorily implemented on a variety and combination of wide area networks, local area networks, enterprise networks, and the like.

According to aspects of the disclosed subject matter, a network node on the network 108 is an online merchant 110. Through various network protocols, the online merchant 110 offers one or more items (products and/or services) for sale or lease to computer users, such as computer users 101 and 103. Additionally and according to aspects of the disclosed subject matter, as part of a purchase or lease transaction with a purchaser/computer user (indicated by dashed line 1), the online merchant provides a facility (often as simple as a selectable control) to the purchaser to indicate that the purchaser wishes to associate a gift message with the delivery (to a recipient) of the purchased item. In response to a purchaser's indication of an intent to associate a gift message with the purchase of the item, the online merchant provides a set of tools and features that enable the purchaser to create and/or upload a gift message that will be delivered to a recipient of the purchased item.

By way of definition and according to aspects of the disclosed subject matter, a gift message should be viewed as comprising any one or more items of textual content, video content, audio content, image content, data files, and the like. Unlike typical messages that have been offered, the textual content of a gift message is not limited by any particular delivery constraint (e.g., number of characters) or page size, though there may be a practical limit imposed by the online merchant due to storage space of each container. Indeed, according to aspects of the disclosed subject matter, a gift message may include animated textual content interspersed with video and audio content, composed together to create a meaningful message to the recipient. Templates and tools may be offered by the online merchant 110 to assist in the creation of the gift message. In various embodiments, these tools may include the ability of the purchaser to upload content as all or part of the gift message. The various elements (content items) of the gift message are collectively stored in a logical container as the “gift message.”

With the conclusion of a transaction with a purchaser, such as purchaser/computer user 101, the online merchant 110 arranges for the delivery of the purchased item, along with a gift message from the purchaser, to the intended recipient, such as recipient/computer user 103. Arranging the delivery of the purchased item to the recipient may include notifying a logistics provider 112 (as indicated by dashed line 2) via the network 108 of the desired delivery, as well as the physical delivery of the item to some member of the logistic provider. Of course, the logistic provider handles the shipment/delivery of the item to the recipient (according to information provided by the purchaser). Upon delivery, the logistic provider 112 provides a notification (as indicated by dashed line 3) to the online merchant 110 that the delivery is completed. In response to this notification and according to additional aspects of the disclosed subject matter, the online merchant 110 issues a notification to the recipient (as indicated by dashed line 4) that indicates the delivery of the purchased item to the recipient, indicates that there is an associated gift message with the purchased item, and provides information for accessing the gift message. The provided information may comprise an actionable control that causes the gift message to be presented to the computer user/recipient 103 on the recipient's computing device 104, and/or a link (or more accurately, hyperlink) encoded with information for identifying and accessing the associated gift message from an online storage location. In addition to the notification to the recipient, the purchaser may also be notified of the delivery (as indicated by dashed line 5) by the online merchant 110. As further shown, the recipient may then access the gift message provided to the online merchant 110 (as indicated by dashed line 6).

In an alternative embodiment and according to additional aspects of the disclosed subject matter, the online merchant may utilize a third-party online service to host gift messages. In this embodiment, the link to the gift message to the recipient 103 would be directed to the third-party service for access. Additionally, the link to access or present the gift message included in the notification to the recipient may comprise encoded information or data that identifies, to the hosting service (whether it is the online merchant or a third-party online service), which gift message is requested. Additionally, especially in the case where the gift message is hosted by the third-party online service, this encoded information may also include information to identify the online merchant such that the gift message may be presented to the recipient as if it were presented by the online merchant. This presentation may include merchant branding or stylized framing of the gift message such that the recipient is presented with information indicating the source (the online merchant 110) of the purchased item.

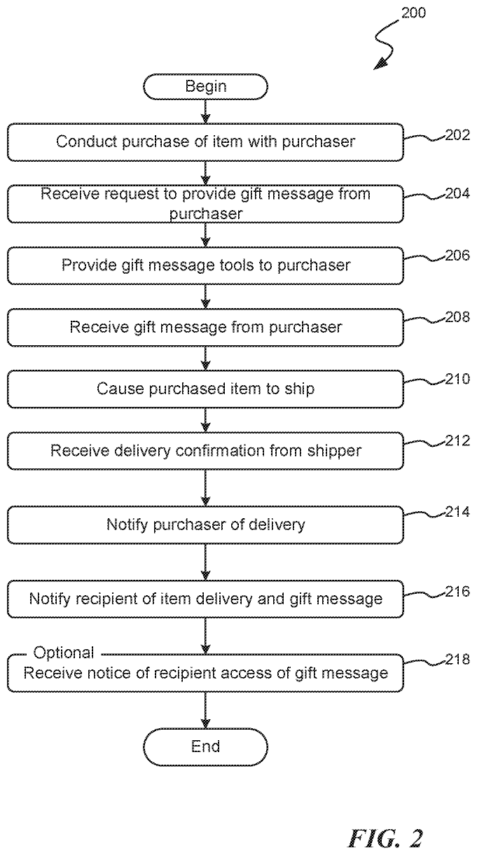

To further illustrate aspects of the disclosed subject matter, reference is now made to FIG. 2. FIG. 2 is a flow diagram illustrating an exemplary routine 200 of an online merchant, such as merchant 110 of FIG. 1, for providing a purchaser-provided gift message for a recipient of a purchased item, in accordance with aspects of the disclosed subject matter. Beginning at block 202, the online merchant engages in and conducts a purchase transaction with a purchaser, such as purchaser 101 of FIG. 1. As will be readily recognized, gathering information regarding who will be receiving the item (when shipped), contact information of the recipient and where to deliver the item, contact information of the purchaser, financial payment information of the purchaser, etc., is a part of the purchase transaction.

According to aspects of the disclosed subject matter, as an additional part of conducting the purchase transaction of an item with the purchaser, at block 204 the online merchant receives a request or indication that the purchaser also wishes to associate a gift message with the item being purchased. As mentioned above, a gift message comprises any one or more items of textual content, video content, audio content, image content, data files, and the like. Moreover, a gift message is not constrained to a fixed number of text characters that is printed and delivered to a recipient upon an invoice. Rather, a gift message is a purchaser-customized multi-media content that is electronically delivered to or accessed by the recipient.

The request or indication that the purchaser wants to associate a gift message with the item may be made by the purchaser activating a control that is specifically provided for the purchaser to make the request. For example, a check box may be clicked which provides notice to the online merchant of the purchaser's intent to associate a gift message with the purchase. In response, at block 206, the online merchant can then provide a set of tools and templates by which the purchaser can create, modify, and/or upload a gift message to be delivered to the recipient of the purchased item. These tools, many of which allow for editing, modification, and/or creation, may include drawing tools, video and/or audio capturing tools, image and textual templates, and the like. The tools may include the ability to upload items of content, e.g., videos, audio content, images, etc., for inclusion within the gift message, and further provide tools for combining, organizing, and packaging all the various elements into a gift message. At block 208, the online merchant receives the gift message from the purchaser.

According to aspects of the disclosed subject matter, uploading, creating and/or editing of a gift message is not required to be a synchronous element of the routine 200. Indeed, the online merchant may facilitate that the purchaser can, at one or more later times or dates, upload, create, and/or edit the gift message. Indeed, in various embodiments, the purchaser may be provided with a gift message identifier (e.g., a code or an encoded hyperlink that permits the purchaser, and/or others, to upload, create, and/or modify a gift message asynchronously and/or subsequent to the purchase of the item, and to do so on multiple occasions. Moreover, the online merchant may provide a feature that notifies the purchaser that a gift message is still required in anticipation of delivering of the purchased item, even providing a “deadline” by which the gift message should be completed in order to be available at the time that the purchased item is delivered to the recipient.

According to aspects of the disclosed subject matter, the online merchant may provide the features that allow for multiple persons to upload, edit and/or create a gift message in association with a single purchased item. For example, siblings may wish to collectively create a gift message for their parents in association with one of the siblings conducting the purchase of a gift item. A suitably configured online merchant may provide this feature to these multiple siblings.

At block 210, after conducting the transaction, the online merchant causes the purchased item to be shipped to the recipient. Typically, though not exclusively, the shipment of the purchased item to the recipient is carried out through a logistics provider, i.e., a shipping service. At block 212, the online merchant (as the party that contracted for the shipment) receives delivery notification of the item to the recipient. As will be readily appreciated, notification of delivery of items is now a near real-time occurrence with the delivery of the item. In response, at block 214, the online merchant notifies the purchaser of the delivery. Additionally and according to aspects of the disclosed subject matter, at block 216, the online merchant notifies the recipient of the delivery of the purchased item and of the gift message. Typically, though not exclusively, the notification is an electronic notification: e.g., an email message, a SMS (short message service) text message, or an MMS (multimedia message service) text message, social networking messages, and the like. Additionally or alternatively, a printed code may be provided to the recipient. These codes, when optically scanned or manually entered into an application or user-interface of a computer, may cause access to the gift message to be provided. In various embodiments, the shipping identifier may be used as a code by the recipient to determine whether a gift message is associated with the delivered, purchased item and, if so, enable access to that gift message.

In various embodiments of the disclosed subject matter, the notification to the recipient includes a link by which the recipient can access or view the gift message. Additionally or alternatively, an invoice (even a gift invoice) with the gift message may include a link by which the recipient can access or view the gift message. Indeed, this printed “link” may comprise a QR code or other, similar type of encoding, i.e., a machine-readable optical label that contains a data, that can be used to navigate to the gift message. When scanned by a suitable app or application, the QR code follows the link embedding in the QR code to present or provide access to the gift message.

At block 218, the online merchant may be optionally notified of the recipient's access of the gift message. This is particularly important information when the gift message is hosted by a third-party online service specifically configured to host such gift messages and provide the access services. Thereafter, routine 200 terminates.

As an alternative to the steps of routine 200 described above, as those skilled in the art will appreciate, in the course of purchasing an item from an online merchant, a purchaser will receive an invoice number that uniquely identifies the purchase transaction. This invoice will typically allow a purchaser to view the purchase transaction, as well as view the status of delivery of any purchased item. According to aspects of the disclosed subject matter, in the event that the purchaser has not already indicated that a purchased item is intended as a gift and would like to associate a gift message with the purchased item, a purchaser may provide this indication in a post-purchase manner by viewing the purchase transaction and taking advantage of an option to add the gift message. While most people would like to have a gift message ready for the recipient at the time of delivery, according to aspects of the disclosed subject matter, a gift message may be created and associated with the purchased item and delivered to the recipient after the recipient has received delivery of the purchased item.

Regarding delivery of the gift message to the recipient, while routine 200 above indicates that delivery of the gift message is carried out at the time of delivery of the purchased item, the disclosed subject matter is not so constrained. In various embodiments of the disclosed subject matter, delivery of the gift message may occur at a specified date (and/or time), including a date that occurs after delivery of the purchased item, as well as a date that precedes delivery of the purchased item. For example, a purchaser may set timing of a corresponding gift message to occur on an anniversary, while actual delivery of the purchased item may have occurred at some point prior to (or after) the anniversary.

While routine 200 is described as an online merchant providing an option to the purchaser to associate a gift message with the purchased item, the disclosed subject matter may be advantageously applied in alternative embodiments. Indeed, in one such embodiment, a logistics provider (e.g., a shipping company) may host its own gift messaging service. In this embodiment, after the logistics provider is charged with delivering the item to a recipient, the logistic provider may message the purchaser with an option to associate a gift message with the purchased item. Typically though not exclusively, this message includes an identifier or code to access a site for providing a gift message and in association with the code, the purchaser (or others to whom the purchaser provided the identifier/code) can, in one or more occasions, visit the location and upload, create, edit and/or modify a gift message, as well as establish timing, coordination with delivery, and notification channels for delivering the gift message to the recipient.

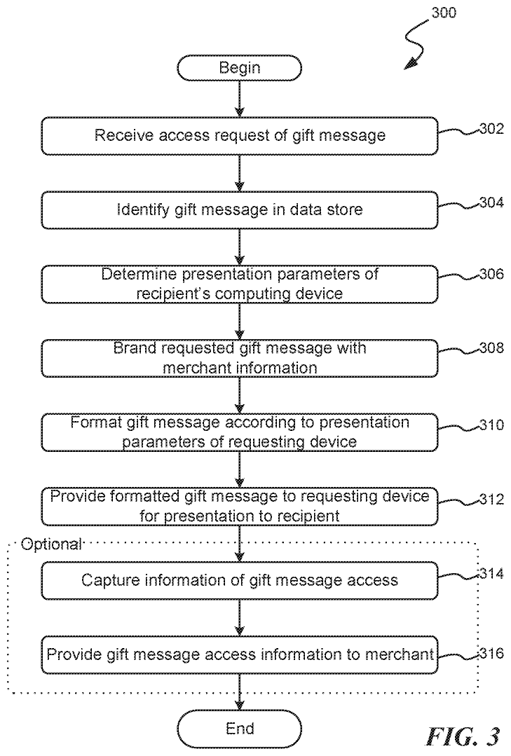

Turning now to FIG. 3, FIG. 3 is a flow diagram illustration an exemplary routine 300 for providing access to a gift message to an intended recipient, in accordance with aspects of the disclosed subject matter. As discussed above, a gift message may be hosted by the online merchant from which a gift item was purchased or may be hosted by a third-party online service offering hosting services for gift messages. Routine 300 is implemented by a “hosting service” of the gift message—whether it is the online merchant or a third-party online service.

Beginning at block 302, the hosting service receives an access request of the gift message. As suggested above, the access request may be the result of following a link provided to the recipient corresponding to a specific gift message associated with the purchased item. This link may include information identifying the specific gift message for which access (or presentation) is requested, as well as the online merchant from which the purchased item was obtained. Other information that may be included with this access request may include, by way of illustration and not limitation, the identity of the requesting party/recipient, the type of device upon which the recipient is making the request for access, whether the access is to retrieve the gift message to the recipient's computing device or to cause a presentation of the gift message to the recipient, and the like.

At block 304, the hosting service identifies the requested gift message in an accessible gift message table according to the information associated with the requested access. More particularly, the link followed by the recipient may include a gift message identifier, the identity of the recipient, etc., all of which may be used to identify the requested gift message in the associated gift message table.

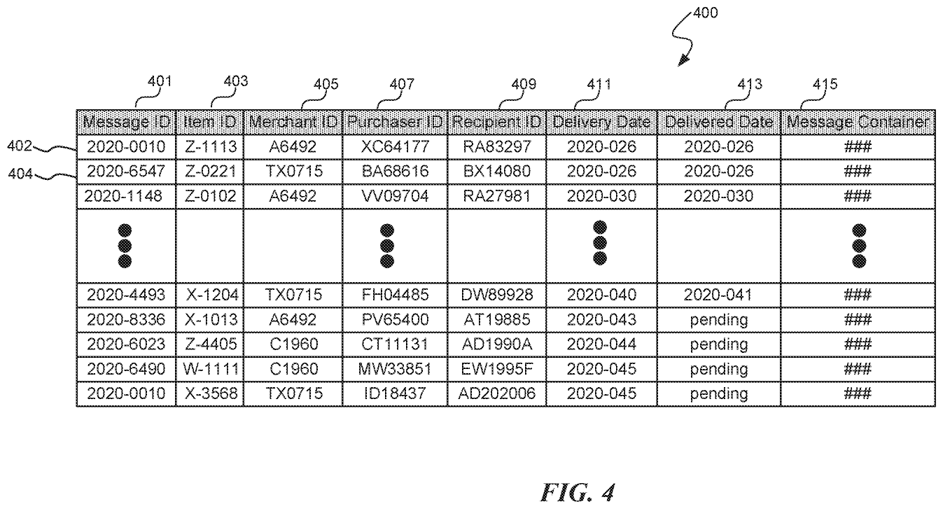

Regarding the gift message table mentioned above, FIG. 4 is a block diagram illustrating an exemplary, logical gift message table 400 for managing gift messages according to aspects of the disclosed subject matter. As shown in FIG. 4, the gift message table 400 includes a plurality of records, including records 402 and 404, each record represented as horizontal rows of fields. For illustration purposes and without limitation, the fields include a message identifier field 401 corresponding to a unique identifier of a gift message, an item identifier 403 identifying the purchased item (or group of purchased items) to which a specific gift message is associated, a merchant identifier 405 that identifies the particular merchant from which the item was purchased, a purchaser identifier 407 that uniquely identifies the purchaser of the item, a recipient identifier 409 that identifies the recipient of the purchased item and associated gift message, a delivery date 411 indicative of the intended date of delivery of the item to the recipient, a delivered date 413 indicative of the actual delivery date of the purchased item to the recipient, and a message container 415 that holds a gift message for delivery to a recipient. According to various embodiments of the disclosed subject matter, indices and reverse indices may be used to identify gift messages from within the gift message table 400, as well as to identify merchants for branding the gift messages. Moreover, this information further allows the purchaser to be able to update, edit or create a gift message for later access by or presentation to a recipient.

After identifying the record corresponding to the gift message, at block 306, the hosting service determines one or more presentation parameters of the recipient's computing device. As indicated above, the access request may include information regarding the type of computing device used to make the request. Based on this, or additional interchanges between the hosting service and the recipient's computing device, one or more presentation parameters are determined. These presentation parameters may include, by way of illustration and not limitation, bandwidth capabilities between the hosting service and the recipient's computing device, display and/or audio capabilities and throughput of the recipient's computing device, storage capacity of the recipient's computing device, and the like.

After determining the presentation parameters of the recipient's computing device, at block 308 the presentation of the gift message, or the actual gift message itself, may be optionally branded to have a look and feel that corresponds to the online merchant who sold the item to the purchaser. Branding may further include information related to the purchased item available from the online merchant, including but not limited to related items, consumable components for the purchased item, and the like. The gift message (or its presentation) may be further branded with merchant offers or promotions of other items or goods not related to the purchased item.

After any optional branding, at block 310, the identified gift message may be formatted for presentation according to the presentation parameters determined in block 306. Of course, if the request is to access for downloading, it may be that no formatting occurs. On the other hand, if the request is for a presentation of the gift message, the gift message may be formatted and/or scaled to accommodate the parameters and abilities of the recipient's current computing device. At block 312, the formatted (for presentation) gift message is provided to the recipient's computing device for presentation to the recipient.

Optionally, at block 314, information regarding access of the gift message by the recipient is captured and in block 316, this information may be provided to the online merchant. Thereafter, routine 300 terminates.

Regarding routines 200 and 300 described above, as well as other routines and/or processes described or suggested herein, while these routines/processes are expressed in regard to discrete steps, these steps should be viewed as being logical in nature and may or may not correspond to any specific actual and/or discrete execution steps of a given implementation. Also, the order in which these steps are presented in the various routines and processes, unless otherwise indicated, should not be construed as the only or best order in which the steps may be carried out. Moreover, in some instances, some of these steps may be combined and/or omitted.

Optimizations of routines may be carried out by those skilled in the art without modification of the logical process of these routines and processes. Those skilled in the art will recognize that the logical presentation of steps is sufficiently instructive to carry out aspects of the claimed subject matter irrespective of any specific development or coding language in which the logical instructions/steps are encoded. Additionally, while some of these routines and processes may be expressed in the context of recursive routines, those skilled in the art will appreciate that such recursive routines may be readily implemented as non-recursive calls without actual modification of the functionality or result of the logical processing. Accordingly, the particular use of programming and/or implementation techniques and tools to implement a specific functionality should not be construed as limiting upon the disclosed subject matter.

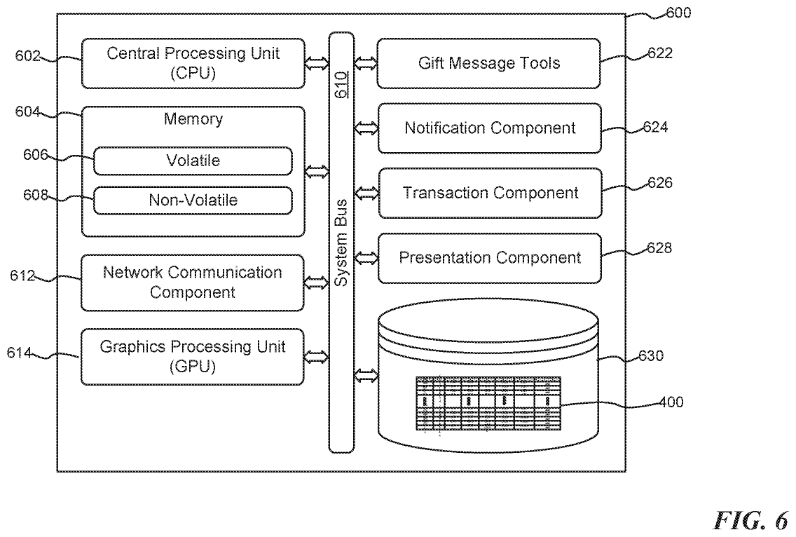

Of course, while these routines and/or processes include various novel features of the disclosed subject matter, other steps (not listed) may also be included and carried out in the execution of the subject matter set forth in these routines, some of which have been suggested above. Those skilled in the art will appreciate that the logical steps of these routines may be combined or be comprised of multiple steps. Steps of the above-described routines may be carried out in parallel or in series. Often, but not exclusively, the functionality of the various routines is embodied in software (e.g., applications, system services, libraries, and the like) that is executed on one or more processors of computing devices, such as the computer system described in FIG. 6 below. Additionally, in various embodiments, all or some of the various routines may also be embodied in executable hardware modules including, but not limited to, systems on chips (SoC's), codecs, specially designed processors and or logic circuits, and the like.

As suggested above, these routines and/or processes are typically embodied within executable code blocks and/or modules comprising routines, functions, looping structures, selectors and switches such as if-then and if-then-else statements, assignments, arithmetic computations, and the like that, in execution, configure a computing device to operate in accordance with the routines/processes. However, the exact implementation in executable statement of each of the routines is based on various implementation configurations and decisions, including programming languages, compilers, target processors, operating environments, and the linking or binding operation. Those skilled in the art will readily appreciate that the logical steps identified in these routines may be implemented in any number of ways and, thus, the logical descriptions set forth above are sufficiently enabling to achieve similar results.

While many novel aspects of the disclosed subject matter are expressed in executable instructions embodied within applications (also referred to as computer programs), apps (small, generally single or narrow purposed applications), and/or methods, these aspects may also be embodied as computer executable instructions stored by computer-readable media, also referred to as computer-readable storage media, which (for purposes of this disclosure) are articles of manufacture. As those skilled in the art will recognize, computer-readable media can host, store and/or reproduce computer executable instructions and data for later retrieval and/or execution. When the computer executable instructions that are hosted or stored on the computer-readable storage devices are executed by a processor of a computing device, the execution thereof causes, configures and/or adapts the executing computing device to carry out various steps, methods and/or functionality, including those steps, methods, and routines described above in regard to the various illustrated routines and/or processes.

Examples of computer-readable media include but are not limited to: optical storage media such as Blu-ray discs, digital video discs (DVDs), compact discs (CDs), optical disc cartridges, and the like; magnetic storage media including hard disk drives, floppy disks, magnetic tape, and the like; memory storage devices such as random-access memory (RAM), read-only memory (ROM), memory cards, thumb drives, and the like; cloud storage (i.e., an online storage service); and the like. While computer-readable media may reproduce and/or cause to deliver the computer executable instructions and data to a computing device for execution by one or more processors via various transmission means and mediums, including carrier waves and/or propagated signals, for purposes of this disclosure computer-readable media expressly excludes carrier waves and/or propagated signals.

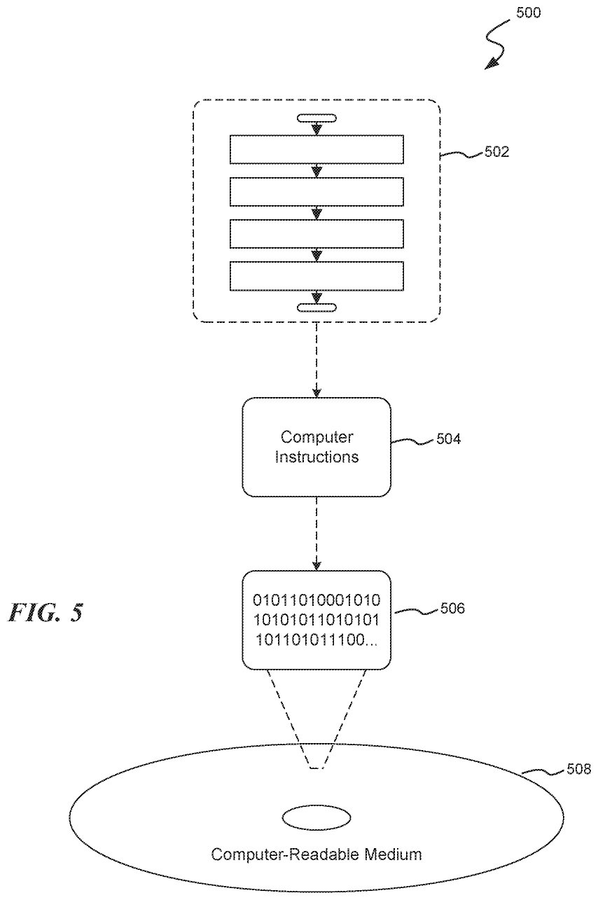

Regarding computer-readable media, FIG. 5 is an exemplary computer-readable medium 500 bearing instructions for providing a purchaser-provided gift message to a recipient in conjunction with the purchase of an item, in accordance with aspects of the disclosed subject matter.

As shown in FIG. 5, the computer-readable medium 500 comprises a computer-readable structure 508 (e.g., a CD-R, DVD-R or a platter of a hard disk drive), on which is encoded computer-readable data 506. This computer-readable data 506 in turn comprises a set of computer instructions 504 configured to operate according to one or more of the principles set forth herein. In one such embodiment, the processor-executable instructions 504, in execution on a computer system, may configure the computer system to provide a purchaser-provided gift message to a recipient in conjunction with the purchase of an item, in accordance with aspects of the disclosed subject matter. As those skilled in the art will appreciate, the processor-executable instructions are typically, though not exclusively, generated from text-based instructions 502 that are converted to the processor-executable instructions by a compilation process.

Turning to FIG. 6, FIG. 6 is a block diagram illustrating logical, executable components of an exemplary computer system 600 suitable for providing a purchaser-provided gift message to a recipient in conjunction with the purchase of an item, in accordance with aspects of the disclosed subject matter. In various embodiments, the various components of the computer system 600 may be executed to carry out one or more functions on an online merchant, such as online merchant 110. Alternatively, the various components of the computer system 600 may be executed to operate as a hosting service that hosts gift messages for online merchants, as discussed above.

The exemplary computer system 600 typically includes one or more central processing units (or CPUs), such as CPU 602, and further includes at least one memory 604. In various embodiments, the CPU 602 and memory 604, as well as other components of the computer system, are interconnected by way of a system bus 610.

As will be appreciated by those skilled in the art, the memory 604 typically (but not always) comprises both volatile memory 606 and non-volatile memory 608. Volatile memory 606 retains or stores information so long as the memory is supplied with power. In contrast, non-volatile memory 608 can store (or persist) information even when a power supply is not available. In general, RAM (random access memory) and CPU cache memory are examples of volatile memory 606 whereas ROM (read-only memory), solid-state memory devices, memory storage devices, and/or memory cards are examples of non-volatile memory 608.

As will be further appreciated by those skilled in the art, the CPU 602 executes instructions retrieved from memory 604, from computer-readable media such as computer-readable media 508 of FIG. 5, and/or other executable components in carrying out the various functions of the disclosed subject matter. The CPU 602 may be comprised of any of a number of available processors such as single-processor, multi-processor, single-core units, and multi-core units, which are well known in the art.

Further still, the illustrated computer system 600 typically also includes a network communication interface 612 for interconnecting this computing system with other devices, computers and/or services over a computer network, such as network 108 of FIG. 1. The network communication interface 612, sometimes referred to as a network interface card or NIC, communicates over a network using one or more communication protocols via a physical/tangible (e.g., wired, optical fiber, etc.) connection, a wireless connection such as Wi-Fi or Bluetooth communication protocols, NFC, or a combination thereof. As will be readily appreciated by those skilled in the art, a network communication interface, such as network communication interface 612, is typically comprised of hardware and/or firmware components (and may also include or comprise executable software components) that transmit and receive digital and/or analog signals over a transmission medium (i.e., the network 108).

The illustrated computer system 600 also includes a graphics processing unit (GPU) 614. As those skilled in the art will appreciate, a GPU is a specialized processing circuit designed to rapidly manipulate and alter memory. Initially designed to accelerate the creation of images in a frame buffer for output to a display, due to their ability to manipulate and process large quantities of memory, GPUs are advantageously applied in a variety of scenarios including training machine learning models such as deep neural networks, which also manipulate large amounts of data.

In addition to the above, the illustrated computer system 600 further includes an executable transaction component 626. In execution, the transaction component 626 provides the functionality of the online merchant to conduct a purchase (or lease) transaction with a purchaser, such as purchaser 101. This functionality includes the selection of an item to purchase, gathering of information regarding a delivery location of the item, gathering contact information of the purchaser as well as contact information of the recipient, purchase instrument information, and the like. Additionally, the transaction component 626 further provides the functionality to the purchaser to indicate a desire to associate a gift message with the purchased item that is to be delivered to a recipient at (or about) the time of delivery.

The illustrated computer system 600 also includes an executable gift message tools component 622. In execution, the gift message tools component 622 provides the functionality to the purchaser, and others, to edit, modify, and/or create a gift message. These tools may include drawing tools, video and/or audio capturing tools, image and textual templates, and the like. Additionally, the tools may include the ability to upload items of content, e.g., videos, audio content, images, etc., for inclusion within the gift message, and further provide tools for combining, editing, organizing, and packaging all the various elements into a gift message for delivery to the recipient of the purchased item, such as recipient 103.

An executable notification component 624 of the exemplary computer system 600 configures the computer system to receive notification from a logistics provider regarding the delivery of a purchased item to a recipient, and to further provide notifications to the purchaser and the recipient upon delivery of the purchased item. As suggested above, the notification component 624 may be configured to encode a link to an associated gift message and include the encoded link for the notification to, at least, the recipient. As indicated above, this encoded link, when followed as is known in the art, provides access to the gift message stored at a hosting service on the network. Indeed, as discussed, the hosting service may correspond to the online merchant 110, may correspond to a third-party service to the online merchant, or both. The encoded link may enable the recipient to download the gift message to a designated electronic storage location of the recipient, and/or may enable the recipient (or others) to view a presentation of the gift message, formatted according to the various presentation parameters that are associated with a current computing device of the recipient/viewer.

In addition to the above, the notification component 624 may provide notifications to the purchaser at a predetermined time prior to an estimated delivery of the purchased item, reminding the purchaser to complete or provide a gift message for the recipient, and may further provide an anticipated deadline for its completion.

An executable presentation component 628 of the exemplary computer system 600 configures the computer system to identify a gift message in a gift message table 400 stored in a datastore 630 according to information of an encoded link. The presentation component 628 can use one or more indices or reverse indices to identify the specific gift message to be viewed. Additionally, the presentation component 628 is configured to scale the gift message according to presentation parameters (including transmission bandwidth abilities) of the recipient's computing device such that the gift message is presented in an optimal manner in view of the recipient's computing device. This scaling may include, by way of illustration and not limitation, reducing the resolution of visual elements of the gift message, and/or reducing fidelity of audio elements of the gift message. In addition to adapting or scaling the gift message to the recipient's computing device, the presentation component 628 may be further configured to brand the presentation of the gift message according to templates or styles of the online merchant from which the item was purchased.

Regarding the various components of the exemplary computer system 600, those skilled in the art will appreciate that many of these components may be implemented as executable software modules stored in the memory of the computing device, as hardware modules and/or components (including SoCs—system on a chip), or a combination of the two. Indeed, components may be implemented according to various executable embodiments including, but not limited to, executable software modules that carry out one or more logical elements of the processes described in this document, or as hardware and/or firmware components that include executable logic to carry out the one or more logical elements of the processes described in this document. Examples of these executable hardware components include, by way of illustration and not limitation, ROM (read-only memory) devices, programmable logic array (PLA) devices, PROM (programmable read-only memory) devices, EPROM (erasable PROM) devices, and the like, each of which may be encoded with instructions and/or logic which, in execution, carry out the functions described herein.

While various novel aspects of the disclosed subject matter have been described, it should be appreciated that these aspects are exemplary and should not be construed as limiting. Variations and alterations to the various aspects may be made without departing from the scope of the disclosed subject matter.

What is claimed:

1. A computer-implemented method for providing a purchaser-provided gift message to a recipient of a purchased item, the method comprising:
receiving an indication from a purchaser of an item to associate a gift message with the purchased item for delivery to the recipient in conjunction with the delivery of the purchased item;
obtaining the gift message from the purchaser of the purchased item, the gift message comprising one or more items of video content, image content, audio content, and textual content;
storing the gift message in a gift message table containing a plurality of gift messages in a data store in association with the purchased item;
receiving a notice of delivery of the purchased item to the recipient;
electronically notifying the recipient of delivery of the purchased item and including access information for accessing the gift message associated with the purchased item;
receiving an access request from the recipient for the gift message associated with the purchased item;
identifying the gift message associated with the purchased item from the gift message table according to the access information included in electronically notifying the recipient of delivery of the purchased item; and
providing electronic access to the gift message associated with the purchased item.

2. The computer-implemented method of claim 1 further comprising:
providing one or more electronic tools for creating, editing and/or modifying the gift message associated with the purchased item; and
wherein obtaining the gift message from the purchaser of the purchased item comprises obtaining the gift message from the purchaser's use of the one or more electronic tools to at least create the gift message.

3. The computer-implemented method of claim 1, further comprising:
providing one or more electronic tools for uploading, creating, editing and/or modifying the gift message associated with the purchased item; and
wherein obtaining the gift message from the purchaser of the purchased item comprises obtaining one or more items of content from the purchaser as the gift message.

4. The computer-implemented method of claim 3 further comprising utilizing the one or more electronic tools for editing and/or modifying the uploaded gift message.

5. The computer-implemented method of claim 1, wherein obtaining the gift message from the purchaser of the purchased item and storing the gift message in the gift message table is conducted in an asynchronous manner after receiving the indication from the purchaser of the item to associate the gift message with the purchased item.

6. The computer-implemented method of claim 1, wherein providing electronic access to the gift message associated with the purchased item comprises:
generating a presentation of the gift message associated with the purchased item; and
providing the presentation of the gift message in response to receiving the access request from the recipient for the gift message.

7. The computer-implemented method of claim 6, further comprising:
determining one or more presentation parameters for presenting the gift message to the recipient; and
wherein generating the presentation of the gift message associated with the purchased item comprises generating the presentation of the gift message associated with the purchased item according to the determined presentation parameters.

8. The computer-implemented method of claim 7, wherein generating the presentation of the gift message associated with the purchased item further comprises branding the presentation of the gift message associated with the purchased item according to information corresponding to an online merchant from which the purchased item was purchased.

9. The computer-implemented method of claim 1, further comprising printing encoded information on an invoice that is delivered with the purchased item to the recipient, wherein the encoded information is configured such that, when optically scanned by the recipient's computing device, initiates the access request for the gift message associated with the purchased item.

10. A computer-readable medium bearing computer-executable instructions which, when executed on a computing system comprising at least a processor executing the instructions, carry out a method for providing a purchaser-provided gift message to a recipient of a purchased item, the method comprising:
maintaining a gift message table in a data store, the gift message table storing information regarding a plurality of gift messages associated with a corresponding plurality of purchased items;
receiving an indication from a purchaser of an item to associate a gift message with the purchased item for delivery to the recipient in conjunction with the delivery of the purchased item;
obtaining the gift message from the purchaser of the purchased item, the gift message comprising one or more items of video content, image content, audio content, and textual content;
storing the gift message in the gift message table in association with the purchased item;
receiving notice of delivery of the purchased item to the recipient;
electronically notifying the recipient of delivery of the purchased item and including access information for accessing the gift message associated with the purchased item;
receiving an access request from the recipient for the gift message associated with the purchased item;
identifying the gift message associated with the purchased item from the gift message table according to the access information included in electronically notifying the recipient of delivery of the purchased item; and
providing electronic access to the gift message associated with the purchased item.

11. The computer-readable medium of claim 10, wherein the method further comprises:
providing one or more electronic tools for creating, editing and/or modifying the gift message associated with the purchased item; and
wherein obtaining the gift message from the purchaser of the purchased item comprises obtaining the gift message from the purchaser's use of the one or more electronic tools to at least create the gift message.

12. The computer-readable medium of claim 10, the method further comprising:
providing one or more electronic tools for uploading, creating, editing and/or modifying the gift message associated with the purchased item; and
wherein obtaining the gift message from the purchaser of the purchased item comprises obtaining one or more items of content from the purchaser as the gift message.

13. The computer-readable medium of claim 12, the method further comprising utilizing the one or more electronic tools for editing and/or modifying the uploaded gift message.

14. The computer-readable medium of claim 10, wherein obtaining the gift message from the purchaser of the purchased item and storing the gift message in the gift message table is conducted in an asynchronous manner after receiving the indication from the purchaser of the item to associate the gift message with the purchased item.

15. The computer-readable medium of claim 10, wherein providing electronic access to the gift message associated with the purchased item comprises:
generating a presentation of the gift message associated with the purchased item; and
providing the presentation of the gift message in response to receiving the access request from the recipient for the gift message.

16. The computer-readable medium of claim 15, the method further comprising:
determining one or more presentation parameters for presenting the gift message to the recipient; and
wherein generating the presentation of the gift message associated with the purchased item comprises generating the presentation of the gift message associated with the purchased item according to the determined presentation parameters.

17. The computer-readable medium of claim 16, wherein generating the presentation of the gift message associated with the purchased item further comprises branding the presentation of the gift message associated with the purchased item according to information corresponding to an online merchant from which the purchased item was purchased.

18. A computer system for providing a purchaser-provided gift message to a recipient of a purchased item, the computer system comprising a processor and a memory, wherein the processor executes instructions stored in the memory as part of or in conjunction with additional components to provide the gift message to the recipient, and configures the computer system to at least:
maintain a gift message table in a data store, the gift message table storing information regarding a plurality of gift messages associated with a corresponding plurality of purchased items;
receive an indication from a purchaser of an item to associate the gift message with the purchased item for delivery to the recipient in conjunction with the delivery of the purchased item;
obtain the gift message from the purchaser of the purchased item, the gift message comprising one or more items of video content, image content, audio content, and textual content;
store the gift message in the gift message table in association with the purchased item;
receive notice of delivery of the purchased item to the recipient;
electronically notify the recipient of delivery of the purchased item and include access information for accessing the gift message associated with the purchased item;
receive an access request from the recipient for the gift message associated with the purchased item;
identify the gift message associated with the purchased item from the gift message table according to the access information included in electronically notifying the recipient of delivery of the purchased item; and
provide electronic access to the gift message associated with the purchased item.

19. The computer system of claim 18, wherein the computer system is further configured to at least:
provide one or more electronic tools for creating, editing and/or modifying the gift message associated with the purchased item; and
wherein obtaining the gift message from the purchaser of the purchased item comprises obtaining the gift message from the purchaser's use of the one or more electronic tools to at least create the gift message.

20. The computer system of claim 18, wherein the computer system is further configured to at least:
provide one or more electronic tools for uploading, creating, editing and/or modifying the gift message associated with the purchased item; and
wherein in obtaining the gift message from the purchaser of the purchased item the computer system obtains one or more items of content from the purchaser as the gift message.
